(19) United States
(12) Patent Application Publication
(10) Pub. No.: US 2018/0014530 A1
(43) Pub. Date: Jan. 18, 2018

(54) Decoy Anchor Pulley System

(71) Applicant: Stephen Gunther Sturm, Yorktown, VA (US)

(72) Inventor: Stephen Gunther Sturm, Yorktown, VA (US)

(21) Appl. No.: 15/461,498

(22) Filed: Mar. 17, 2017

Related U.S. Application Data
(60) Provisional application No. 62/309,859, filed on Mar. 17, 2016.

(51) Int. Cl. A01M 31/06; B66D 1/60

(52) U.S. Cl. CPC A01M 31/06; B66D 1/60

(57) ABSTRACT

An apparatus for permitting a decoy system to be activated by a jerk cord with little motion and force. An apparatus comprising of a pulley, a swivel, and a shackling mechanism used to attach to an anchoring system. The system is self righting when deployed and relatively easy to activate compared to other systems available.

### FIELD OF THE INVENTION

The invention generally relates to waterfowl hunting decoys.

### BACKGROUND

While a variety of decoy activation systems exist a there is a general lack of the ability to easily deploy a pulley system that activates with little force and rights itself to minimize friction.

There remains a need for a system that allows linear force to be translated into decoy motion with little motion and rights itself allow for easy deployment.

### SUMMARY

An anchor with a shackle attached to pulley with a swivel action. The decoy anchor pulley system.

The decoy anchor pulley system is designed to allow for the easy activation of decoys with a cord.

In one aspect, a pulley attached to a grappling anchor with a articulating shackle or other similar retaining device mechanism. In other embodiments, the pulley is attached with a swiveling system retained by a shackle or other similar retaining device.

In another aspect, the decoy anchor pulley system is attached to a weight.

In another aspect, the decoy anchor pulley system is attached to a weighted chain.

In another aspect, the decoy anchor pulley system is attached to pole that is sunk into the mud or the bottom of the water way being hunted with the system.

In another aspect the device is attached to a mushroom, Danforth, grapnel, iron, Norhill, claw, plough or other anchor design.

In another aspect the decoy anchor system is attached to any device designed to hold the decoy anchor system in place.

### BRIEF DESCRIPTION OF THE FIGURES

The invention and the following detailed description of certain embodiments thereof may be understood by reference to the following figures:

FIG. 1 is a view of the decoy anchor pulley system;

FIG. 2 is another view of the anchor pulley system attached to an anchor.

FIG. 3 is a view of the Jerk Butt System.

FIG. 4 is view Jerk Butt System in use with the decoy anchor pulley system.

### DETAILED DESCRIPTION

The apparatus described herein may be used as an ammunition holder by a user in order to facilitate a quick reloading of a gun.

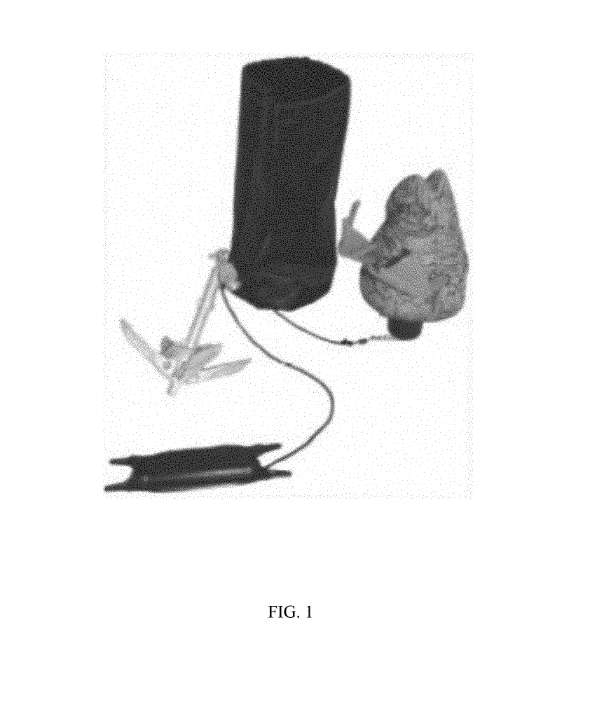

FIG. 1 is a view of the ammunition holder 2. The ammunition holder 2 consists of a retaining device 6 and at least one magnet 8.

The support backing 4 may consist of one entire loop of fabric. In other embodiments, such as the one shown, it may also use a clasp 10 to fasten the support backing to a user's arm (As in FIG. 5) or other desired location. The ammunition 12 is held in place by having one end of the ammunition 12 inserted into the retaining device 6 and magnetically holding the other end of the ammunition 12 with the magnet 8.

The ammunition holder may consist of one or more retaining devices 6 in order to hold one or more rounds of ammunition 12. In the embodiment shown, there are three rounds of ammunition 12 shown because this is a configuration that could be used by a duck hunter due to the limitation of rounds that can be used at any one time.

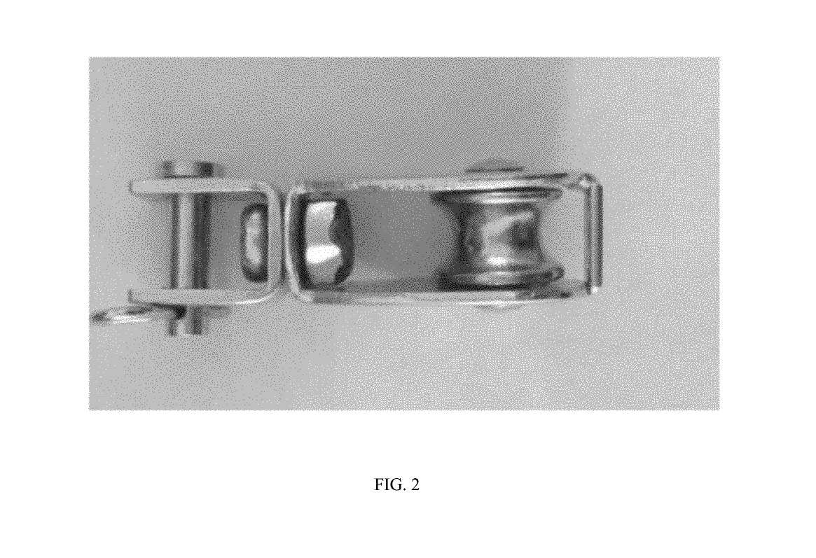

FIG. 2 is another view of the ammunition holder.

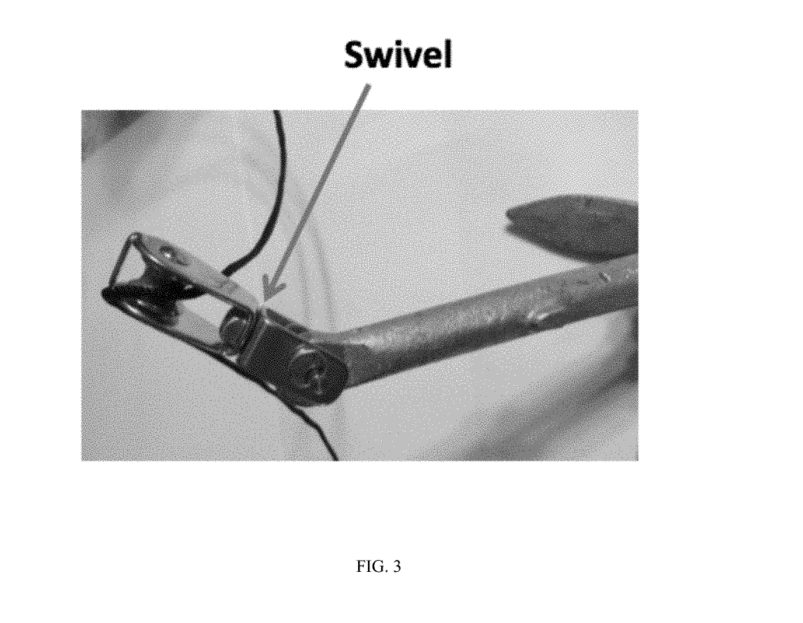

FIG. 3 is another view of the ammunition holder.

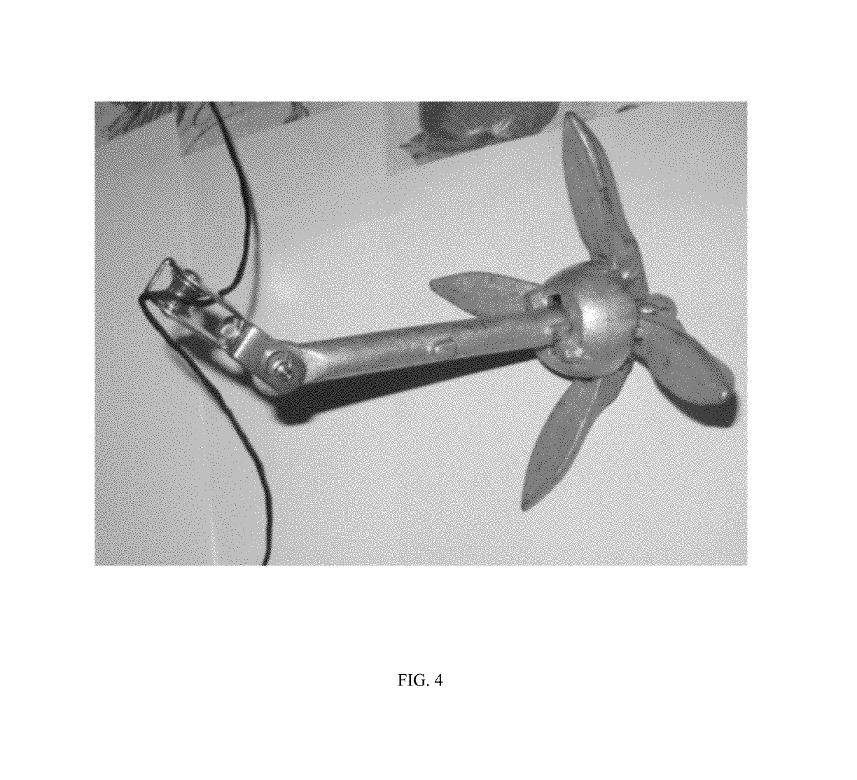

FIG. 4 is another view of the ammunition holder.

FIG. 5 is a single ammunition holder. In this embodiment, a clip may be used to attach an ammunition holder to an item such as a bag pack.

FIG. 6 is a view of the ammunition holder 2 as used by a person. As shown, the ammunition holder 2 may be attached to user's arm in order to allow ready access to the rounds in order for a quick reload to be performed.

FIG. 7 is a set of charts showing different levels of pull strength using a variety of methods.

While particular embodiments of the present invention have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

What is claimed is:

1. An apparatus comprising:
a swivel having a first end and a second end;
a pulley attached to said first end of said swivel; and
an anchor rotatably attached to said second end of said swivel;
wherein said anchor keeps the apparatus from moving when the apparatus is activated and the swivel allows the pulley to rotate in multiple directions.

2. The apparatus of claim 1 further comprising:
a decoy;
a first end of a cord is attached to the decoy;
wherein said cord is looped through said pulley and a second end of the cord is activated by a user such that said decoy can manipulated.

3. The apparatus of claim 1 further comprising:
a decoy;
a first end of a cord is attached to the decoy;
wherein said swivel and said pulley rotate to allow the decoy to orient itself.
